(19) United States
(12) Patent Application Publication
(10) Pub. No.: US 2026/0307427 A1
(43) Pub. Date: Oct. 8, 2026

(54) MARKER PEN

(71) Applicant: Wenzhou Jinma Stationery Manufacturing Co., Ltd., Wenzhou (CN)

(72) Inventors: Kaicheng LI, Wenzhou (CN); Haolei DONG, Wenzhou (CN); Weixia DING, Wenzhou (CN)

(73) Assignee: Wenzhou Jinma Stationery Manufacturing Co., Ltd., Wenzhou (CN)

(21) Appl. No.: 19/387,710

(22) Filed: Nov. 13, 2025

(30) Foreign Application Priority Data
Apr. 8, 2025 (CN) 202520651626.2

(51) Int. Cl. B43K 8/06

(52) U.S. Cl. CPC B43K 8/06

(57) ABSTRACT

Provided is a marker pen, including a pen body, a pen tip and an ink-guiding core, an ink chamber is provided inside the pen body, the ink chamber is filled with ink, the pen tip absorbs ink through the ink-guiding core, the pen body is connected to a sealing cap for closing the ink chamber, one end of the sealing cap is provided with an ink outlet for the pen tip to pass through, and the other end is provided with a protruded ink absorption head for the ink-guiding core to pass through, the inner wall of the ink absorption head is provided with a protruded stepped portion, the ink-guiding core includes a contact section that contacts the pen tip, an abutting section that abuts against the stepped portion, and an extension section that extends into the ink chamber.

### CROSS-REFERENCE TO RELATED APPLICATIONS

This application claims the benefit of priority of Chinese application number 202520651626.2, filed on Apr. 8, 2025. The entire contents of the above-mentioned applications are incorporated herein by reference.

### TECHNICAL FIELD

The present disclosure relates to the technical field of stationery, and in particular, to a marker pen.

### BACKGROUND

A marker pen, also known as a sign pen, is a type of colored drawing pen used for writing or drawing. It contains ink and is usually provided with a cap and a hard pen tip. Marker pens use volatile ink for quick, one-time sketches and are commonly used in scenarios such as product design, advertising slogans, poster creation, and other artistic works.

Existing marker pens include a pen body, a pen cap, an ink-guiding core and a pen tip. Ink is filled in the inner cavity of the pen body, and the pen tip draws the ink through the ink-guiding core, thereby allowing ink discharge during writing.

However, to ensure that the pen tip can continuously discharge ink for writing, the ink-guiding core is required to continuously supply ink to the pen tip. Therefore, there is a need to provide a marker pen capable of maintaining good and stable ink discharge.

### SUMMARY

An objective of the present disclosure is to overcome the defects and deficiencies of the existing technology and to provide a marker pen. The marker pen of the present disclosure has an ink absorption head capable of stably supporting an ink-guiding core to prevent the ink-guiding core from wobbling. The ink-guiding core extends through the ink absorption head into the ink chamber, thereby increasing the contact area between the ink-guiding core and the ink, thereby ensuring good and stable ink discharge.

The technical proposal provided by the present disclosure is as follows: a marker pen, including a pen body, a pen tip and an ink-guiding core, in which an ink chamber is provided inside the pen body, the ink chamber is filled with ink, the pen tip absorbs ink through the ink-guiding core, a sealing cap is connected to the pen body for closing the ink chamber, one end of the sealing cap is provided with an ink outlet for the pen tip to pass through, and the other end of thereof is provided with a protruded ink absorption head for the ink-guiding core to pass through, an inner wall of the ink absorption head is provided with a stepped portion, the ink-guiding core includes a contact section in contact with the pen tip, an abutting section abutting against the stepped portion, and an extension section extending into the ink chamber.

An ink-blocking cotton is further arranged inside the sealing cap, and the ink-guiding core further includes a penetrating section penetrating the ink-blocking cotton.

A first limiting portion is provided on an inner wall of the sealing cap at an end close to the ink outlet, and a second limiting portion is provided on the inner wall of the sealing cap at an end close to the ink absorption head, and the ink-blocking cotton is disposed in abutment between the first limiting portion and the second limiting portion.

The inner wall of the ink absorption head is further provided with a plurality of windows communicating with the ink chamber.

A ventilation groove is respectively provided on the inner wall of the ink absorption head at a position corresponding to each window, and an interior of the sealing cap is communicated with the ink chamber through the ventilation grooves.

The ink absorption head is provided with a plurality of stepped portions, and the stepped portions are evenly distributed on the inner wall of the ink absorption head along a circumferential direction, and one of the windows and one of the ventilation grooves are arranged between adjacent two of the stepped portions.

An ink-guiding surface is respectively provided on the inner wall of the ink absorption head at a position corresponding to each window. The ink-guiding surface is inclined toward the ink chamber, and an acute angle is formed between the ink-guiding surface and an axis of the ink-guiding core.

Two ends of the pen body are respectively provided with one sealing cap and one ink-guiding core; two pen tips are provided, which are a broad tip and a fine tip, respectively. One of the sealing caps is connected to the broad tip, and the other one of the sealing caps is connected to the fine tip; each end of the pen body is further fitted with a pen cap.

The advantageous effects of the present disclosure are as follows: the marker pen of the present disclosure has an ink absorption head that can stably support the ink-guiding core, that is, the abutting section of the ink-guiding core abuts against the stepped portion of the inner wall of the ink absorption head to prevent the ink-guiding core from wobbling, and the ink-guiding core extends through the ink absorption head into the ink chamber, increasing the contact area between the ink-guiding core and the ink. This allows the ink-guiding core to draw more ink, thereby maintaining an adequate ink supply in the pen tip and ensuring smooth and stable ink delivery.

### BRIEF DESCRIPTION OF THE DRAWINGS

In order to more clearly illustrate the embodiments of the present disclosure or the technical proposals in the existing technology, the drawings used in the description of the embodiments or existing technology are briefly introduced below. It is apparent that the drawings described below merely illustrate some embodiments of the present disclosure. For those skilled in the art, obtaining other drawings based on these drawings without inventive effort also falls within the scope of the present disclosure.

FIG. 1 is a schematic exploded view of a marker pen according to the present disclosure;

FIG. 2 is a schematic cross-sectional view of the present disclosure;

FIG. 3 is a partial enlarged view of area A shown in FIG. 2;

FIG. 4 is a schematic diagram of FIG. 3 with the ink-guiding core removed; and

FIG. 5 is a schematic diagram of the interior of the sealing cap of the present disclosure.

Reference signs are as follows: 1 pen body, 2 pen tip, 3 ink-guiding core, 4 ink chamber, 5 sealing cap, 6 ink outlet, 7 ink absorption head, 8 stepped portion, 9 contact section, 10 abutting section, 11 extension section, 12 ink-blocking cotton, 13 penetrating section, 14 first limiting portion, 15 second limiting portion, 16 window, 17 ventilation groove, 18 ink-guiding surface, 19 broad tip, 20 fine tip, 21 pen cap.

### DETAILED DESCRIPTION OF EMBODIMENTS

In order to make the purpose, technical proposals and advantages of the present disclosure clearer, the present disclosure will be described in further detail below with reference to the accompanying drawings.

It should be noted that the terms "first" and "second" used in the embodiments of the present disclosure are for the purpose of distinguishing two non-identical entities or non-identical parameters with the same name. It can be understood that "first" and "second" are only for the convenience of description and should not be construed as limiting the embodiments of the present disclosure. This explanation will not be repeated in subsequent embodiments.

The directional and positional terms used in this disclosure, such as "uppe", "lower", "front", "rear", "left", "right", "inner", "outer", "top", "bottom," and "lateral", are merely for reference to the orientation or position shown in the drawings. Therefore, these directional and positional terms are intended only to facilitate the description and understanding of the present disclosure and should not be construed as limiting the scope of the present disclosure.

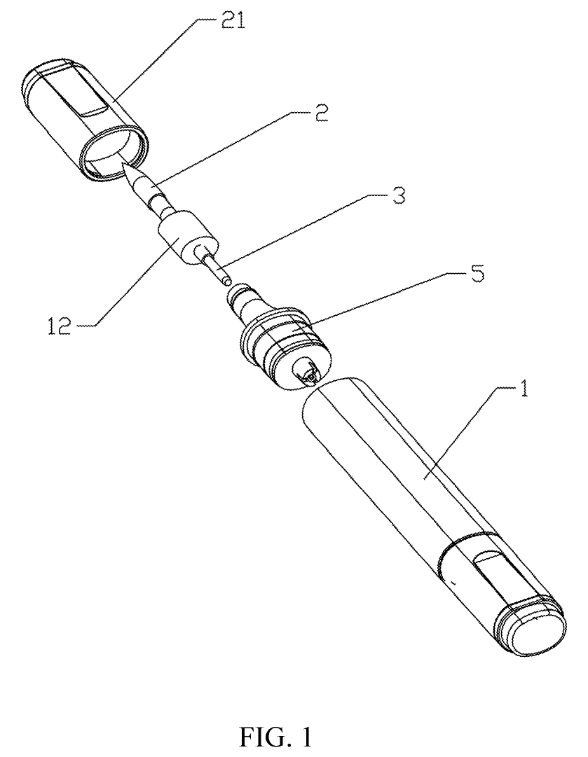

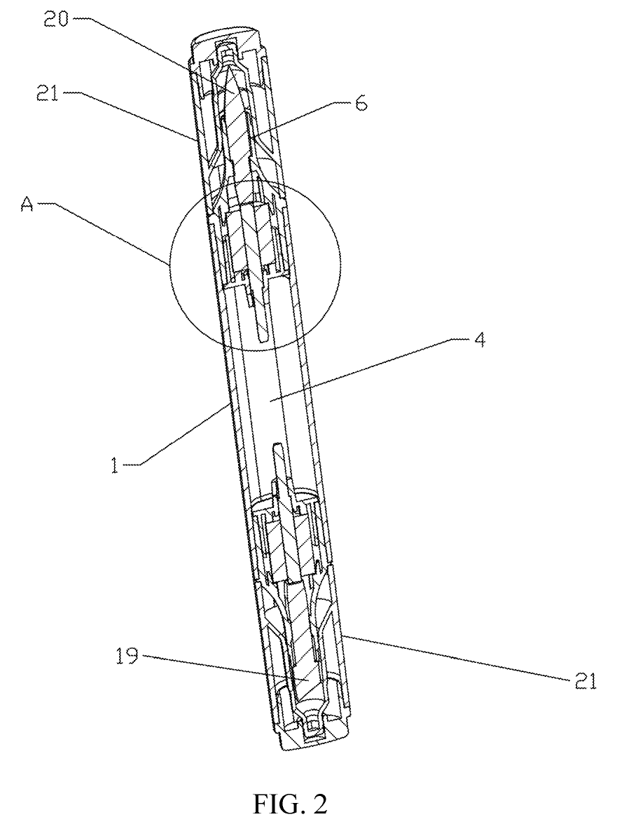

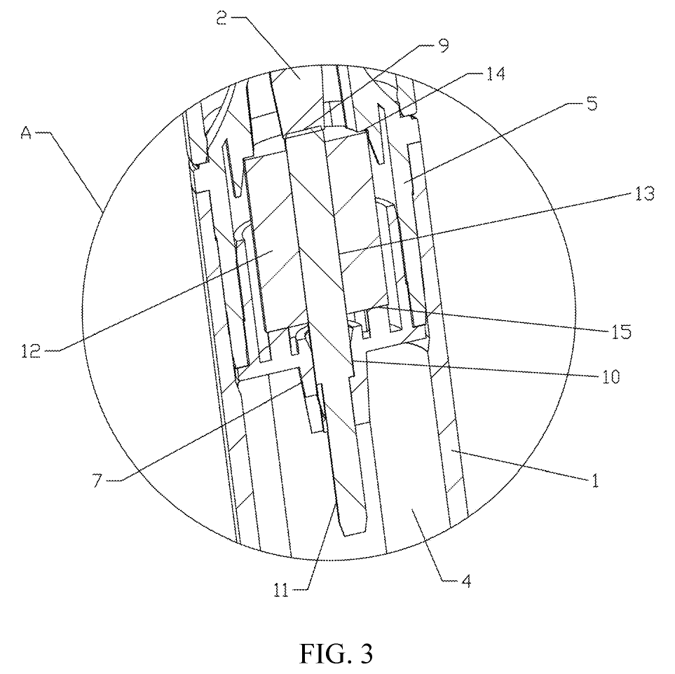

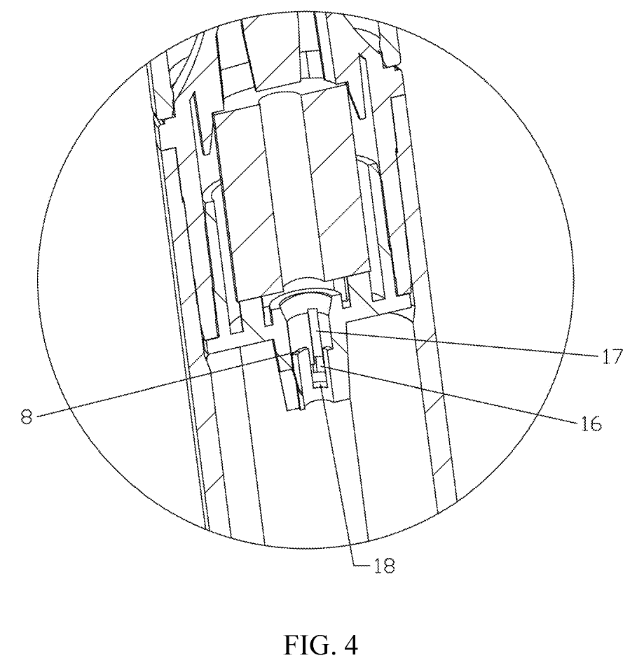

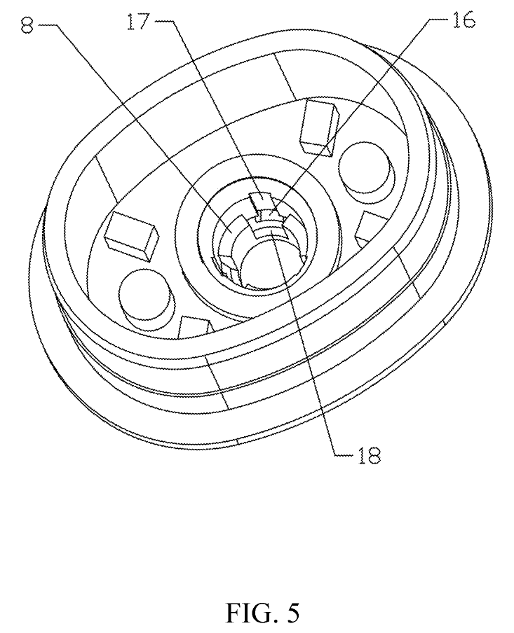

As shown in FIGS. 1 to 5, an embodiment of the present disclosure provides a marker pen, including a pen body 1, a pen tip 2 and an ink-guiding core 3. An ink chamber 4 is provided inside the pen body 1, and ink is filled in the ink chamber 4. The pen tip 2 absorbs ink through the ink-guiding core 3. The pen body 1 is connected to a sealing cap 5 for closing the ink chamber 4. One end of the sealing cap 5 is provided with an ink outlet 6 for the pen tip 2 to pass through, and the other end is provided with a protruded ink absorption head 7 for the ink-guiding core 3 to pass through. The inner wall of the ink absorption head 7 is provided with a protruded stepped portion 8. The ink-guiding core 3 includes a contact section 9 in contact with the pen tip 2, an abutting section 10 abutting against the stepped portion 8, and an extension section 11 extending into the ink chamber 4.

The advantageous effects of this arrangement are as follows: the marker pen of the present disclosure has an ink absorption head that can stably support the ink-guiding core, that is, the abutting section of the ink-guiding core abuts against the stepped portion on the inner wall of the ink absorption head to prevent the ink-guiding core from wobbling, and the ink-guiding core extends through the ink absorption head into the ink chamber, increasing the contact area between the ink-guiding core and the ink. The ink-guiding core can absorb more ink, thereby maintaining an adequate ink supply in the pen tip and ensuring smooth and stable ink delivery.

Furthermore, an ink-blocking cotton 12 is provided inside the sealing cap 5, and the ink-guiding core 3 further includes a penetrating section 13 penetrating the ink-blocking cotton 12.

The advantageous effects of this arrangement are as follows: by providing an ink-blocking cotton outside of the ink-guiding core, the ink in the ink-guiding core can be effectively prevented from leaking out, so that most of the ink in the ink-guiding core can be transferred to the pen tip, further ensuring stable ink delivery.

Further, a first limiting portion 14 is provided on the inner wall of the sealing cap 5 at an end close to the ink outlet 6, and a second limiting portion 15 is provided on the inner wall thereof at an end close to the ink absorption head 7, and the ink-blocking cotton 12 is in abutment between the first limiting portion 14 and the second limiting portion 15.

The advantageous effects of this arrangement are as follows: the ink-blocking cotton is abutted against the first limiting portion and the second limiting portion to prevent the ink-blocking cotton from shifting, thereby ensuring that the ink-blocking cotton can stably prevent ink leakage.

Furthermore, the inner wall of the ink absorption head 7 is provided with a plurality of windows 16 communicating with the ink chamber 4.

The advantageous effects of this arrangement are as follows: the ink in the ink chamber flows into the ink absorption head through the window, further increasing the contact area between the ink-guiding core and the ink.

Further, a ventilation groove 17 is respectively formed on the inner wall of the ink absorption head 7 at a position corresponding to each window 16, and the interior of the sealing cap 5 is in communication with the ink chamber 4 through the ventilation grooves 17.

The advantageous effects of this arrangement are as follows: the ventilation grooves allow air inside the sealing cap and air inside the ink chamber to circulate to achieve air flow balance. Even under negative pressure, the ink absorption core can still draw ink normally. The depth of the ventilation grooves is very shallow, which ensures the normal circulation of air without causing ink to leak into the interior of the sealing cap.

Further, a plurality of stepped portions 8 are provided, and the plurality of stepped portions 8 are evenly distributed along the circumferential direction on the inner wall of the ink absorption head 7, and one of the windows 16 and one of the ventilation grooves 17 are respectively arranged between adjacent two of the stepped portions 8.

The advantageous effects of this arrangement are as follows: the outer wall of the abutting section fits with the inner wall of the ink absorption head, the outer wall of the extension section fits with the inner wall of the stepped portions, and the stepped portions are alternately arranged with the ventilation grooves and the windows to avoid interference, providing a compact structure that is easy to manufacture.

Further, an ink-guiding surface 18 is provided on the inner wall of the ink absorption head 7 at a position corresponding to each window 16, the ink-guiding surface 18 is inclined toward the ink chamber 4, and an acute angle is formed between the ink-guiding surface 18 and the axis of the ink-guiding core 3.

The advantageous effects of this arrangement are as follows: the ink in the gap between the ink absorption head and the ink-guiding core is guided to the ink-guiding core through the ink-guiding surface, facilitating the ink-guiding core to absorb ink, while also preventing residual ink in the gap, thereby avoiding waste.

Further, two ends of the pen body 1 are each respectively provided with one sealing cap 5 and one ink-guiding core 3, and two pen tips 2 are provided, the two pen tips 2 are respectively a broad tip 19 and a fine tip 20. One of the sealing caps 5 is connected to the broad tip 19, and the other one of the sealing caps 5 is connected to the fine tip 20, and a pen cap 21 is fitted at each end of the pen body 1.

The advantageous effects of this arrangement are as follows: a set of sealing cap and ink-guiding core with the same structure are mounted at both ends of the pen body, with a broad tip at one end and a fine tip at the other end, forming a dual-tip marker pen. This design is suitable for a wider range of writing scenarios, allowing both broad and fine strokes, thereby enhancing practicality.

The above disclosure is only preferred embodiments of the present disclosure and should not be construed as limiting the scope of the present disclosure. Therefore, any equivalent variations made in accordance with the claims of the present disclosure shall still fall within the scope of the present disclosure.

What is claimed is:

1. A marker pen, comprising a pen body (1), a pen tip (2) and an ink-guiding core (3), an ink chamber (4) being provided inside the pen body (1), the ink chamber (4) being filled with ink, and the pen tip (2) absorbing ink through the ink-guiding core (3), wherein the pen body (1) is connected to a sealing cap (5) for closing the ink chamber (4), one end of the sealing cap (5) is provided with an ink outlet (6) for the pen tip (2) to pass through, and the other end thereof is provided with a protruded ink absorption head (7) for the ink-guiding core (3) to pass through, an inner wall of the ink absorption head (7) is provided with a protruded stepped portion (8), and the ink-guiding core (3) includes a contact section (9) in contact with the pen tip (2), an abutting section (10) abutting against the stepped portion (8), and an extension section (11) extending into the ink chamber (4).

2. The marker pen according to claim 1, wherein an ink-blocking cotton (12) is further arranged inside the sealing cap (5), and the ink-guiding core (3) further comprises a penetrating section (13) penetrating the ink-blocking cotton (12).

3. The marker pen according to claim 2, wherein a first limiting portion (14) is provided on an inner wall of the sealing cap (5) at an end close to the ink outlet (6), and a second limiting portion (15) is provided on the inner wall of the sealing cap (5) at an end close to the ink absorption head (7), and the ink-blocking cotton (12) is disposed in abutment between the first limiting portion (14) and the second limiting portion (15).

4. The marker pen according to claim 1, wherein the inner wall of the ink absorption head (7) is further provided with a plurality of windows (16) communicating with the ink chamber (4).

5. The marker pen according to claim 4, wherein a ventilation groove (17) is respectively provided on the inner wall of the ink absorption head (7) at a position corresponding to each window (16), and an interior of the sealing cap (5) is in communication with the ink chamber (4) through the ventilation grooves (17).

6. The marker pen according to claim 5, wherein the ink absorption head is provided with a plurality of stepped portions (8) evenly distributed along a circumferential direction on the inner wall of the ink absorption head (7), and one of the windows (16) and one of the ventilation grooves (17) are respectively arranged between adjacent two of the stepped portions (8).

7. The marker pen according to claim 4, wherein an ink-guiding surface (18) is provided on the inner wall of the ink absorption head (7) at a position corresponding to each window (16), the ink-guiding surface (18) is inclined toward the ink chamber (4), and an acute angle is formed between the ink-guiding surface (18) and an axis of the ink-guiding core (3).

8. The marker pen according to claim 1, wherein two ends of the pen body (1) are each provide with one sealing cap (5) and one ink-guiding core (3), respectively, two pen tips (2) are provided, and the two pen tips (2) are respectively a broad tip (19) and a fine tip (20), one of the sealing caps (5) is connected to the broad tip (19), and the other one of the sealing caps (5) is connected to the fine tip (20), and a pen cap (21) is respectively fitted at the two ends of the pen body (1).
